(19) United States
(12) Patent Application Publication
(10) Pub. No.: US 2005/0152054 A1
(43) Pub. Date: Jul. 14, 2005

(54) Reflective element holder for rearview mirror

(75) Inventors: Wayne J. Rumsey, Holland, MI (US); John W. Carter, Holland, MI (US); Jeremy A. Fogg, Holland, MI (US)

Correspondence Address: PRICE, HENEVELD, COOPER, DEWITT, & LITTON,;LLP/GENTEX CORPORATION, 695 KENMOOR, S.E., P O BOX 2567, GRAND RAPIDS, MI, 49501, US

(73) Assignee: Gentex Corporation

(21) Appl. No.: 11/005,720

(22) Filed: Dec. 7, 2004

Related U.S. Application Data
(60) Provisional application No. 60/536,471, filed on Jan. 14, 2004.

(51) Int. Cl. G02B 5/08

(52) U.S. Cl. 359/879; 359/871

(57) ABSTRACT

A rearview mirror subassembly for a vehicle comprising a housing and a reflective element in the housing. An elastomer abuts against at least a portion of the reflective element to thereby maintain the reflective element in position within the housing.

### CROSS-REFERENCE TO RELATED APPLICATION

This application claims the benefit of U.S. Provisional Application No. 60/536,471, filed Jan. 14, 2004, entitled REFLECTIVE ELEMENT HOLDER FOR REARVIEW MIRROR.

### BACKGROUND OF THE INVENTION

The present invention relates to rearview mirrors, and in particular to holders for maintaining reflective elements in position within the rearview mirrors.

Electrochromic mirrors have gained wide acceptance in modern passenger vehicles due to their ability to darken as a way of reducing glare from other vehicle headlights. Typically, electrochromic mirrors include a pair of glass elements with electrochromic material therebetween that can be darkened to reduce the brightness of light reflected from a reflector material associated with the rear glass element. Usually, the glass elements are each at least about 2.2 mm thick so that the glass elements have sufficient internal structure to be self-supporting and resistant to flexure that would unacceptably distort the glass elements and result in distorted reflected images. Glass elements that are thinner than 2.2 mm traditionally are so thin that they may unacceptably deform, crack, or break. This can occur as a result of many different factors, such as from a person cleaning or pressing on the front glass element, or from impact during a vehicle crash, or from stresses generated within the mirror itself. Such stress can come from assembly, from non-uniform thermal expansion of components in the mirror, or from non-uniform support of the glass elements.

Despite the problems associated with thin glass elements, thin glass is very desirable because it results in significant mass reduction in mirror assemblies, which in turn results in reduced mirror vibration and hence improved mirror function. Specifically, reduced mirror mass contributes directly to a reduction in a condition sometimes referred to as a “pendulum effect” which results in mirror vibration. The “pendulum effect” is caused by a mirror assembly having a mass supported in cantilever off of a vehicle front windshield. The vibration of the mirror increases as the mass of the mirror increases and as a length of the cantilever arm increases. The glass elements are good candidates for mass reduction because two glass elements are used and further, both are located at a front of the mirror assembly, at a point farthest from the vehicle front windshield where the cantilever arm is the greatest. In regard to vehicle weight, it is noted that vehicle manufacturers are extremely interested in reducing vehicle weight, even in small amounts. A reason for this is because reduced vehicle weight has several benefits, including improved vehicle gas mileage, improved/reduced emissions, more favorable government standards for emissions (i.e. heavier vehicles face more stringent government standards), and reduced cost associated with less material usage.

One specific problem with glass elements having reduced thickness concerns impact testing. Typically, some vehicle mirrors must pass a vehicle impact test to assure that they are durable and also to assure that they will not contribute unacceptably to flying debris during a vehicle crash. Glass elements made from existing technologies that have a thickness of less than 2.2 mm do not have sufficient strength to pass existing impact test requirements by vehicle manufacturers unless the mirror subassembly is somehow supported on its back surface or the mirror subassembly is reinforced. However, it is very difficult on a production basis to consistently provide a perfectly flat surface that non-distortingly engages and supports such thin glass elements. Also, it is difficult to provide a non-distorting reinforcement since non-uniform stresses unavoidably occur during assembly and while the mirror assembly is in service. At the same time, in conflict with the above, it is desirable to support the thin glass elements in a manner that communicates stress from the impact test against the glass elements directly back to the mirror mounting structure. If possible, this would allow the mirror mounting structure to communicate the impact stress directly to the front windshield which supports it.

Various electrochromic (EC) mirror constructions are known having features that affect impact strength and impact test results. For example, it is known to adhere foam to a rear surface of a rear glass element of an EC mirror subassembly, and to adhere a circuit board or other support structure to the foam. See U.S. Pat. No. 5,671,996. It is known to engage a rear surface of a rear glass element of an EC mirror subassembly with rubber bumpers or metal springs or plastic springs. It is also known to bond front and rear glass elements together with solid-state phase electrochromic material, such that the front and rear glass elements combine to, in effect, form a single beam or plate of glass. However, each of the known arrangements have unwanted functional limitations or provide non-uniform support with high stress areas or “hot spots” that potentially cause unwanted deformation or distortion of thin glass elements in the range of 1.6 mm to 1.1 mm thickness or even lower. Further, no known arrangement provides a uniform non-distorting support against impact breakage across substantially an entire EC mirror subassembly, where the EC mirror subassembly uses unbonded front and rear glass elements that are 1.1 mm to 1.6 mm thick, and that are separated by a solution-phase, or liquid phase gel-type or hybrid EC material therebetween such that the thin glass elements do not directly reinforce each other.

Accordingly, a system solving the aforementioned disadvantages and having the aforementioned advantages is desired.

### SUMMARY OF THE INVENTION

One aspect of the present invention is to provide a rearview mirror subassembly for a vehicle comprising a housing and a reflective element in the housing, with the reflective element having a perimeter. The rearview mirror subassembly further includes an elastomer abutting at least a portion of the perimeter of the reflective element to thereby maintain the reflective element in position within the housing.

Another aspect of the present invention is to provide a rearview mirror subassembly for a vehicle comprising a housing, a reflective element in the housing and an elastomer abutting at least a portion of the reflective element to thereby compress the reflective element between a portion of the housing and the elastomer. The compression of the reflective element is constant for all temperatures.

Yet another aspect of the present invention is to provide a rear view subassembly for a vehicle comprising a housing and a reflective element in the housing. An elastomer is located within the housing and abuts the reflective element with a first compression force. The elastomer has an initial contact area with the reflective element while the reflective element is abutted against the elastomer with the first compression force. The elastomer has a compression contact area with the reflective element while the reflective element is abutting against the elastomer with a second compression force. The second compression force is greater than the first compression force and the compression contact area is greater than the initial contact area. The elastomer adheres to the reflective element over the compression contact area while the reflective element is abutted against the elastomer during the second compression force.

In yet another aspect of the present invention, a method of making a rearview mirror subassembly for a vehicle is provided, with the rearview mirror subassembly including a reflective element within a housing. The method comprises co-molding a first portion of the housing and an elastomer, positioning the reflective element within the housing, and compressing the reflective element between the elastomer and a second portion of the housing to thereby maintain the reflective element in position within the housing.

These and other features, advantages, and objects of the present invention will be further understood and appreciated by those skilled in the art by reference to the following specification, claims and appended drawings.

### BRIEF DESCRIPTION OF THE DRAWINGS

FIG. 1 is a perspective view of an interior rearview mirror including a rearview mirror subassembly of the present invention.

FIG. 2 is an exploded perspective view of the rearview mirror subassembly of a first alternative of the first embodiment of the present invention.

FIG. 3 is a cross-sectional view of the rearview mirror subassembly of the first alternative of the first embodiment of the present invention.

FIG. 4 is an enlarged view of the rearview mirror subassembly of the first alternative of the first embodiment of the present invention of the circled area IV in FIG. 3.

FIG. 5 is a rear perspective view of a board carrier of the rearview mirror subassembly of the first alternative of the first embodiment of the present invention.

FIG. 6 is a rear view of the board carrier of the first alternative of the first embodiment of the present invention.

FIG. 7 is a bottom view of the board carrier of the first alternative of the first embodiment of the present invention.

FIG. 8 is a cross-sectional view of the board carrier of the first alternative of the first embodiment of the present invention taken along the line VIII-VIII of FIG. 5.

FIG. 9 is a rear view of a second option of the first alternative of the board carrier of the first embodiment of the present invention.

FIG. 10 is a cross-sectional view of the board carrier of the first embodiment of the present invention having an elastomer extending from a front face thereof.

FIG. 11 is a partial cross-sectional enlarged view of the rearview mirror subassembly of a second alternative of the first embodiment of the present invention.

FIG. 12 is a partial cross-sectional enlarged view of the rearview mirror subassembly with a modification of the first embodiment of the present invention.

FIG. 13 is a partial cross-sectional enlarged view of the rearview mirror subassembly of a first alternative of a second embodiment of the present invention.

FIG. 14 is a partial cross-sectional enlarged view of the rearview mirror subassembly of a second alternative of the second embodiment of the present invention.

FIG. 14A is a partial cross-sectional enlarged view of the rearview mirror subassembly of a modification of the second alternative of the second embodiment of the present invention.

FIG. 15 is a partial cross-sectional enlarged view of the rearview mirror subassembly of a first alternative of a third embodiment of the present invention.

FIG. 16 is a partial cross-sectional enlarged view of the rearview mirror subassembly of a second alternative of the third embodiment of the present invention.

FIG. 17 is a partial cross-sectional enlarged view of the reflective element and the elastomer of the present invention during a first compression force.

FIG. 18 is a partial cross-sectional enlarged view of the reflective element and the elastomer of the present invention during a second compression force.

FIG. 19A is an elevational view of the side of the interior rearview mirror system constructed according to the present invention connected to a windshield.

FIG. 19B is an elevational view of the rear of the interior rearview mirror system constructed according to the present invention.

FIG. 19C is a plan view of the top of the interior rearview mirror system constructed according to the present invention.

FIG. 20A is an elevational view of the front of the interior rearview mirror system constructed according to the present invention.

FIG. 20B is a plan view of the top of the interior rearview mirror system constructed according to the present invention.

### DETAILED DESCRIPTION OF THE PREFERRED EMBODIMENTS

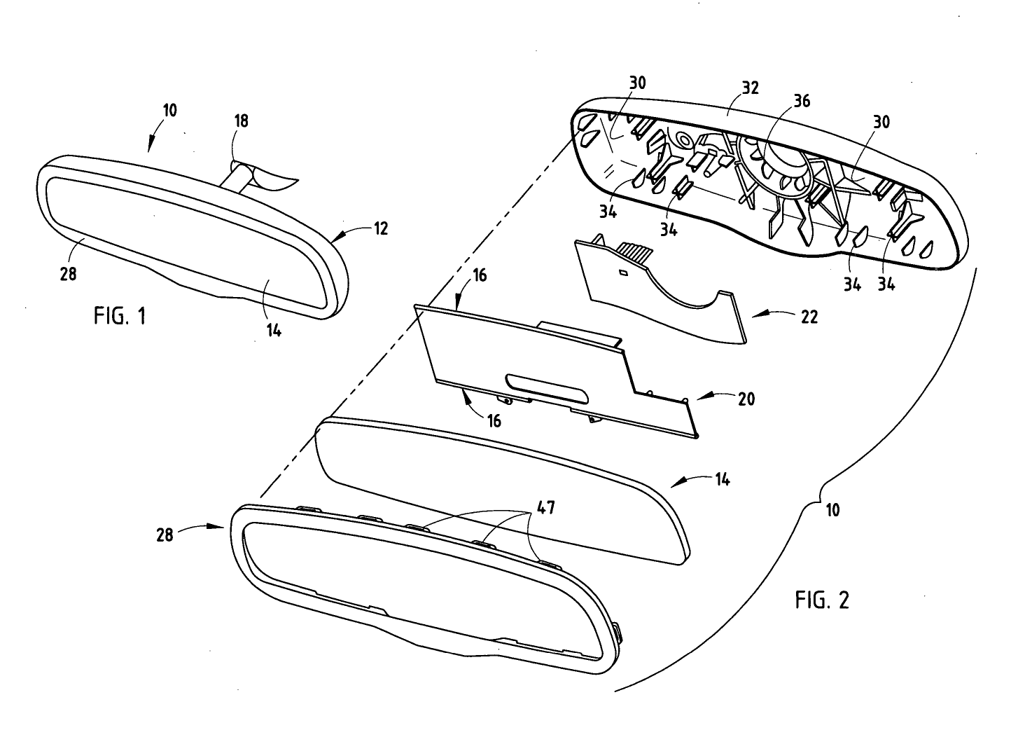

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The reference number 10 (FIG. 2) generally designates a rearview mirror subassembly for a vehicle. The rearview mirror subassembly 10 comprises a housing 12 and a reflective element 14 in the housing 12. An elastomer 16 abuts against at least a portion of the reflective element 14 to thereby maintain the reflective element 14 in position within the housing 12.

The rearview mirror subassembly 10 of the present invention can be used in an interior rearview mirror. When the rearview mirror subassembly 10 is used in an interior rearview mirror, the rearview mirror subassembly 10 is preferably connected to a mounting bracket 18 having a single ball mount (FIG. 1) or a double ball mount. An example of a rearview mirror assembly connected to a mounting bracket having a single ball mount is disclosed in U.S. Pat. No. 6,467,919 entitled MIRROR WITH SPLIT BALL MOUNT AND HOLD-OPEN DEVICE, the entire contents of which are hereby incorporated herein by reference. An example of a rearview mirror assembly connected to a mounting bracket having a double ball mount is disclosed in U.S. Pat. No. 5,377,948 entitled BREAKAWAY REARVIEW MIRROR MOUNTING BRACKET, the entire contents of which are hereby incorporated herein by reference. The mounting bracket 18 is connected to a windshield and/or a headliner of the vehicle as is well know to those skilled in the art and as disclosed in U.S. Pat. Nos. 6,467,919 and 5,377,948.

The rearview mirror subassembly 10 of the present invention can also be used in an exterior rearview mirror. When the rearview mirror subassembly 10 is used in the exterior rearview mirror, the rearview mirror subassembly 10 is typically connected to a motor pack that moves the rearview mirror subassembly 10 according to the requests of a driver of the vehicle. An example of an exterior review mirror including a rearview mirror subassembly is disclosed in U.S. Pat. No. 6,244,716 entitled EXTERIOR MIRROR SUB-ASSEMBLY WITH COMBINED ELECTRONIC CIRCUITRY AND MIRROR ELEMENT, the entire contents of which are hereby incorporated herein by reference.

In a first embodiment of the present invention, the housing 12 of the illustrated rearview mirror subassembly 10 includes a carrier plate 20 located behind the reflective element 14. If the rearview mirror subassembly 10 is used in an exterior rearview mirror, the carrier plate 20 typically holds the reflective element 14 and also movably connects the rearview mirror subassembly 10 to other parts of the exterior rearview mirror such as the motor pack that moves the reflective element 14 according to the requests of a driver of the vehicle. An example of an exterior review mirror including a carrier plate is disclosed in U.S. Pat. No. 6,244,716. Furthermore, the carrier plate 20 can include a printed circuit board 22 connected thereto. An example of an exterior review mirror having a printed circuit board connected to a carrier plate is also disclosed in U.S. Pat. No. 6,244,716. If the rearview mirror subassembly 10 is used in an interior rearview mirror, the carrier plate 20 is typically fixed in position with the housing 12. The carrier plate 20 of the interior rearview mirror can be used to maintain the position of the reflective element 14 and/or carry the circuit board 22. An example of an interior review mirror including a carrier plate and a circuit board is disclosed in U.S. Pat. No. 6,239,899. In both the interior rearview mirror and the exterior rearview mirror, the carrier plate 20 of the first embodiment of the present invention assists in maintaining the reflective element 14 in position within the housing 12.

The illustrated reflective element 14 of the present invention can comprise an electrochromic (EC) mirror subassembly having a front glass element 100 and a rear glass element 102. The illustrated front glass element 100 and the rear glass element 102 are preferably less than 2.2 mm, or more preferably less than about 1.6 mm down to about 1.1 mm. A more detailed description of reflective elements 14 having glass elements of a thickness of 1.1 mm is disclosed in U.S. Pat. No. 6,195,194 entitled LIGHTWEIGHT ELECTROCHROMIC MIRROR, the entire contents of which are hereby incorporated herein by reference.

The illustrated reflective element 14 includes an electrochromic (EC) material positioned between the front glass element 100 and the rear glass element 102. Furthermore, a reflector material is preferably located on either the front surface or the rear surface of the rear glass element 102, depending upon the type of the mirror subassembly. The EC material 35 is preferably a solution phase (sometimes called herein a “liquid-phase” or “gel-type”) EC material, as disclosed in U.S. Pat. No. 4,902,108 entitled SINGLE-COMPARTMENT, SELF-ERASING, SOLUTION-PHASE ELECTROCHROMIC DEVICES, SOLUTIONS FOR USE THEREIN, AND USES THEREOF and U.S. Pat. No. 5,278,693 entitled TINTED SOLUTION-PHASE ELECTROCHROMIC MIRRORS, the entire contents of both of which are hereby incorporated herein by reference. In addition, a hybrid system where part of the electrochromic medium is solid-state and part is solution phase is also contemplated. Solution-phase materials, because of their liquidic or flowable properties, do not rigidly bond the front glass element 100 and the rear glass element 102 together like a completely solid-state EC medium. As a result, the stiffness of the reflective element 14 using 1.1 mm thick glass elements and a solution-phase EC material is more flexible than an EC mirror subassembly having 1.1 mm thick glass elements and a solid-state phase EC material because, in the reflective element 14 having solid-state phase EC material, the thick glass elements are bonded together in a manner that causes them to bend much like a single glass element having their total thickness. Contrastingly, the reflective element 14 with the solution phase EC material bends in a complex manner wherein the thin glass elements bend simultaneously but independently and separately and wherein the solution phase EC material ebbs and flows somewhat in reaction to the stress. The net result is that the mirror subassembly with solution phase EC material tends to be more flexible and concurrently more sensitive to impact than the mirror subassembly with solid-state phase EC material, even where the front and rear glass elements have the same thickness and other properties.

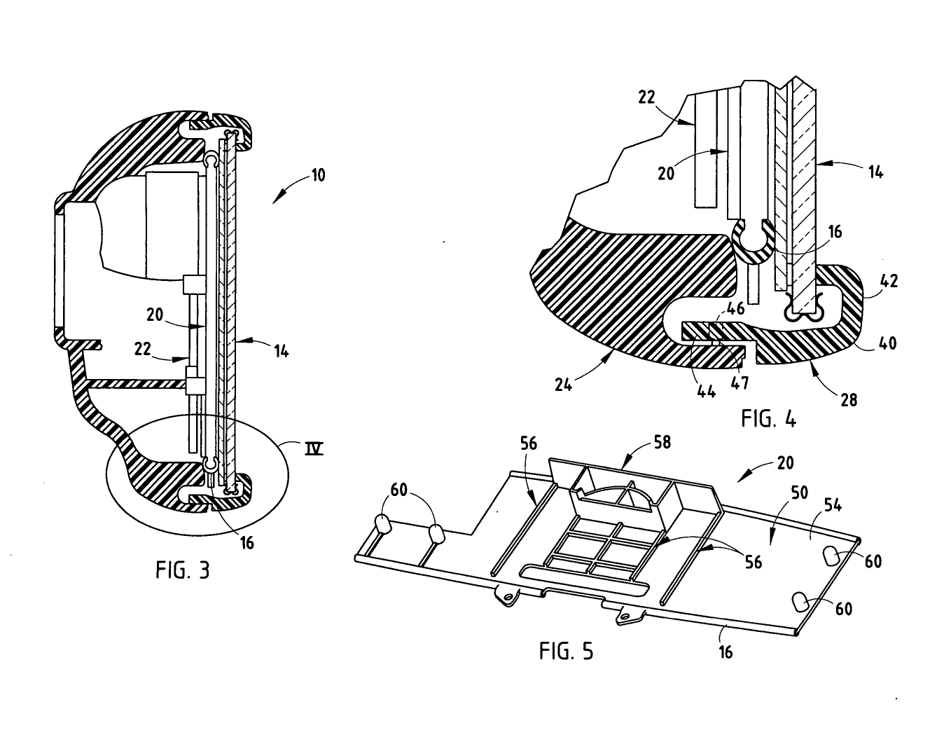

In the first embodiment of the present invention in an interior rearview mirror, the housing 12 includes a rear housing section 24, the circuit board 22, the carrier plate 20 and a bezel 28. The illustrated rear housing section 24 includes a back wall 30 and a sidewall 32. A front edge of the sidewall 32 defines a front opening of the rear housing section 24. The rear housing section 24 includes various bosses 34 and reinforcement ribs 36 to provide structure and support to components within the housing 12. The rear housing section 24 preferably includes a socket-defining member configured to frictionally engage a ball on the mounting bracket 18, to provide an adjustable ball-and-socket joint. The bezel 28 defines a loop and includes a cross section having a structural body portion 40 (FIG. 3), a looping front flange 42 that extends onto and abuts a front surface of the reflective element 14, and a trailing attachment flange 44. The attachment flange 44 is shaped to fit inside the front edge of the sidewall 32 of the rear housing section 24. The attachment flange 44 includes apertures 46 arranged to frictionally snappingly engage hooks 47 inside the front edge of the sidewall 32 of the rear housing section 24. However, it is contemplated that the bezel 28 could be connected to the rear housing section 24 in any manner, including adhesives and mechanical connectors.

FIGS. 2 and 3 illustrate a first alternative of the first embodiment of the present invention, wherein the elastomer 16 is on the carrier plate 20. The carrier plate 20 (FIGS. 2-8) includes a panel 50 having a front face 52 and a rear face 54, spacing ribs 56 extending from the rear face 54 of the panel 50, abutment ribs 58 extending from the rear face 54 of the panel 50 and abutment pegs 60 extending from the rear face 54 of the panel 50. The panel 50 of the carrier plate 20 includes a T-shaped top edge 62 and a T-shaped bottom edge 64, with the elastomer 16 encapsulating the T-shaped top edge 62 and the T-shaped bottom edge 64 of the panel 50. The spacing ribs 56 abut against the circuit board 22 to keep the circuit board 22 spaced from the carrier plate 20. Furthermore, the abutment ribs 58 abut against the bosses 34 and reinforcement ribs 36 of the rear housing section 24 to maintain the carrier plate 20 in position and to transfer any force against the front of the carrier plate 20 to the rear housing section 24 and the mounting bracket 18.

In the illustrated example of the first alternative of the first embodiment of the present invention, the reflective element 14 is compressed between the elastomer 16 on the top edge 62 and the bottom edge 64 of the carrier plate 20 and the looping front flange 42 of the bezel 28. Preferably, as the bezel 28 is connected to the rear housing section 24 of the housing 12, a pair of enlarged ribs 66 extending from the rear housing section 24 abut against the elastomer 16 on the top edge 62 and the bottom edge 64 of the carrier plate 20 to compress the reflective element 14 between the elastomer 16 and the bezel 28, thereby maintaining the reflective element 14 in position within the housing 12.

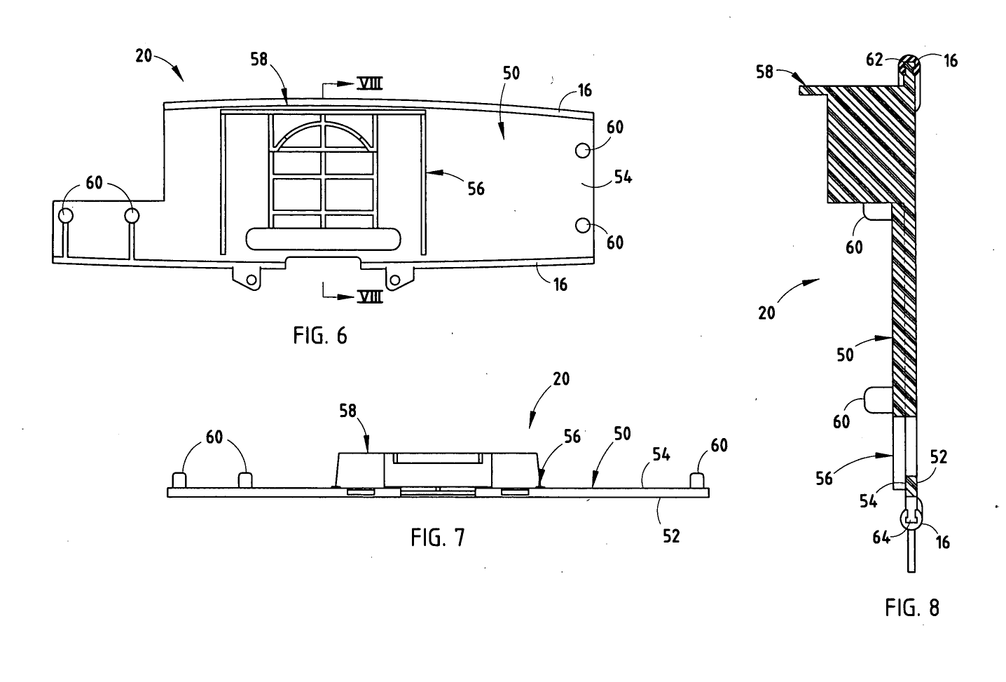

The illustrated front face 52 of the panel 50 of the carrier plate 20 is preferably spaced between 0.25 mm and 1.5 mm from a rear face of the reflective element 14. Most preferably, the front face 52 of the panel 50 of the carrier plate 20 is preferably spaced 0.75 mm from the rear face of the reflective element 14. However, it is contemplated that the front face 52 of the panel 50 of the carrier plate 20 can be spaced any distance from the rear face of the reflective element 14. As illustrated in FIG. 6, the top edge 62 of the carrier plate 20 is preferably curved to follow the curvature of the top edge of the reflective element 14.

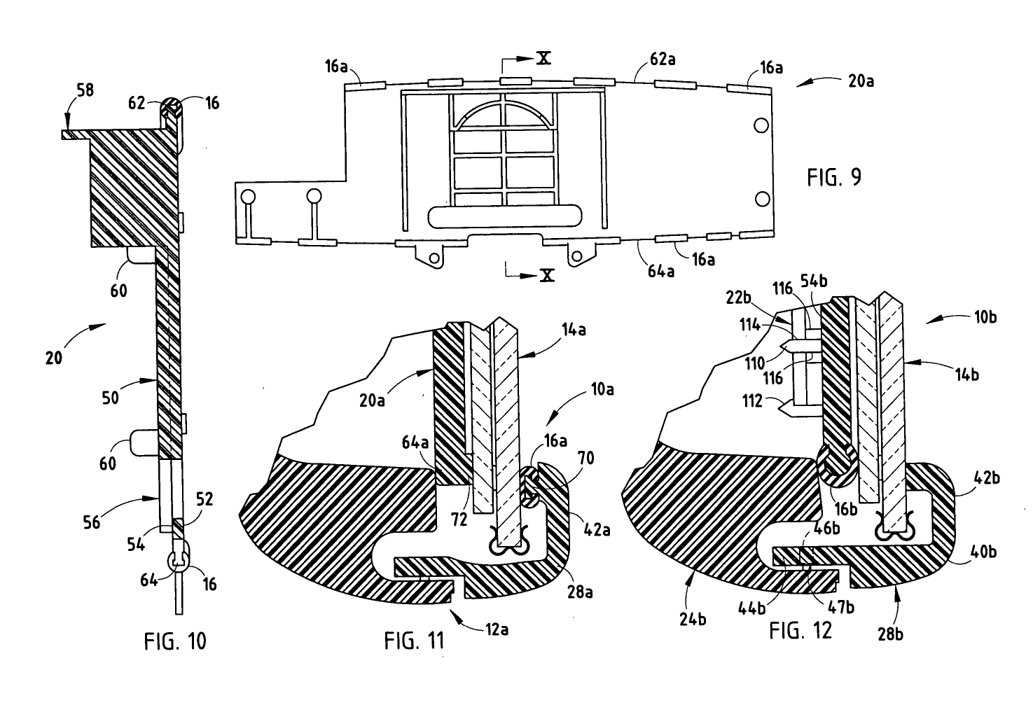

In the illustrated example, the elastomer 16 is located continuously along the top edge 62 and the bottom edge 64 of the carrier plate 20 (FIGS. 5-8). However, in a second option of the first alternative of the first embodiment of the present invention, it is contemplated that the elastomer 16a could be interrupted along the top edge 62a and the bottom edge 64a of the carrier plate 20a (see FIG. 9). Furthermore, it is contemplated that the elastomer 16 could extend from a central region of the front face 52 of panel 50 of the carrier plate 20 in addition to or instead of the elastomer 16 on the top edge 62 and the bottom edge 64 of the carrier plate 20 (interrupted or continuous) (see FIG. 10). The amount of elastomer 16 on the carrier plate 20 and the location of the elastomer 16 can be selected with more elastomeric material resulting in possibly more distortion of the reflective element 14 as discussed below, but with increased reflective element 14 holding capabilities. Conversely, with less elastomer, there will be less possibility of distortion of the reflective element 14, but with decreased reflective element 14 holding capabilities.

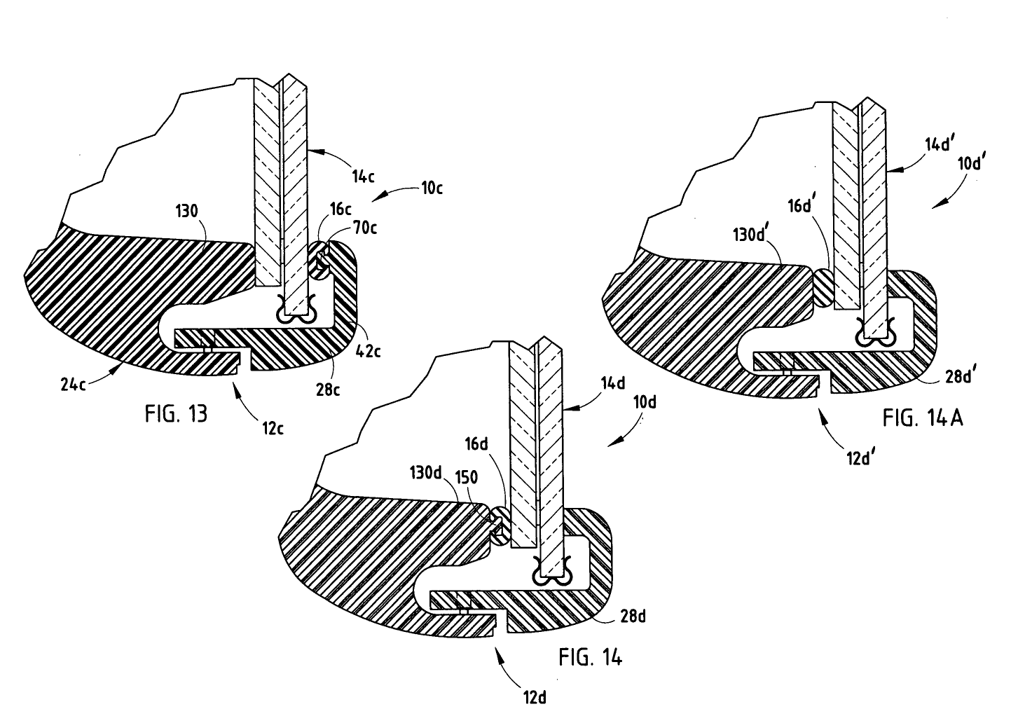

The reference numeral 10a (FIG. 11) generally designates another embodiment of the present invention, having a second alternative of the first embodiment of the rearview mirror subassembly. Since rearview mirror subassembly 10a is similar to the previously described rearview mirror subassembly 10, similar parts appearing in FIGS. 1-8 and FIG. 11, respectively, are represented by the same, corresponding reference number, except for the suffix “a” in the numerals of the latter. The illustrated rearview mirror subassembly 10a includes the elastomer 16a connected to the bezel 28a. As illustrated in FIG. 11, the looping front flange 42a of the bezel 28a includes a T-shaped protrusion 70 with the elastomer 16a encapsulating the T-shaped protrusion 70. Preferably, the end of the looping front flange 42a extends beyond the T-shaped protrusion 70 towards the center of the front face of the reflective element 14a in order to cover the T-shaped protrusion 70 and the elastomer 16a. Furthermore, the carrier plate 20a preferably includes fingers 72 along the top edge 62a and the bottom edge 64a abutting against a rear face of the reflective element 14a. As example of a carrier plate having fingers pressing against a rear face of the reflective element is disclosed in U.S. Pat. No. 6,239,899, discussed above. In the second alternative of the first embodiment of the present invention, the elastomer 16a can be located continuously along the edge of the bezel 28a or can be interrupted along the edge of the bezel 28a. Accordingly, the reflective element 14a is compressed between the elastomer 16a on the bezel 28a and the carrier plate 20a to maintain the reflective element 14a in position within the housing 12a.

The reference numeral 10b (FIG. 12) generally designates another embodiment of the present invention, having an option for the carrier plate 20a used with the rearview mirror subassembly. Since rearview mirror subassembly 10b is similar to the previously described rearview mirror subassembly 10, similar parts appearing in FIGS. 1-8 and FIG. 12, respectively, are represented by the same, corresponding reference number, except for the suffix “b” in the numerals of the latter. The illustrated rearview mirror subassembly 10b includes the circuit board 22b snap fit to the carrier plate 20b. The carrier plate 20b includes a plurality of pegs 110 and hooks 112 extending from the rear face 54b of the carrier plate 20b. The circuit board 22b is connected to the carrier plate 20b by inserting the pegs 110 of the carrier plate 20b into openings 114 in the circuit board 22b. As the pegs 110 are inserted into the openings 114, the hooks 112 will snap over a perimeter portion of the circuit board 22b to connect the circuit board 22b to the carrier plate 20b. The carrier plate 20b preferably includes an elastomeric material 116 extending from a rear face thereof, with the circuit board 22b abutting the elastomeric material 116 when the circuit board 22b is connected to the carrier plate 20b. The elastomeric material 116 can also abut other circuit boards (not shown) used in the rearview mirror subassembly other than the electrochromic circuit board (e.g. circuit boards for a garage door opener, a maplight, switches, etc.). It is contemplated that the elastomeric material 116 can be made from the same material as the elastomer 16b. It is noted that the carrier plate 20b with the pegs 110, hooks 112 and the elastomeric material 116 can be used with the carrier plate 20 of the first alternative of the first embodiment of the rearview mirror subassembly or with the carrier plate 20a of the second alternative of the first embodiment of the rearview mirror subassembly discussed above.

The reference numeral 10c (FIG. 13) generally designates a first alternative of a second embodiment of the rearview mirror subassembly. Since rearview mirror subassembly 10c is similar to the previously described rearview mirror subassembly 10, similar parts appearing in FIGS. 1-8 and FIG. 13, respectively, are represented by the same, corresponding reference number, except for the suffix “c” in the numerals of the latter. The second embodiment of the rearview mirror subassembly 10c does not include a carrier plate 20b. In the first alternative of the second embodiment of the rearview mirror subassembly 10c, the bezel 28c includes the elastomer 16c connected to the bezel 28c similar to the second alternative of the first embodiment of the rearview mirror subassembly 10a discussed above. As illustrated in FIG. 13, the looping front flange 42c of the bezel 28c includes the T-shaped protrusion 70c with the elastomer 16c encapsulating the T-shaped protrusion 70c. Preferably, the end of the looping front flange 42c extends beyond the T-shaped protrusion 70c towards the center of the front face of the reflective element 14c in order to cover the T-shaped protrusion 70c and the elastomer 16c. Furthermore, an extension 130 extending from the rear housing section 24c abuts against the rear face of the reflective element 14c. In the first alternative of the second embodiment of the present invention, the elastomer 16c can be located continuously along the edge of the bezel 28c or can be interrupted along the edge of the bezel 28c. Accordingly, the reflective element 14c is compressed between the elastomer 16c on the bezel 28c and the extension 130 extending from the rear wall of the rear housing section 24c to maintain the reflective element 14c in position within the housing 12c.

The reference numeral 10d (FIG. 14) generally designates a second alternative of the second embodiment of the rearview mirror subassembly. Since rearview mirror subassembly 10d is similar to the previously described rearview mirror subassembly 10c, similar parts appearing in FIG. 13 and FIG. 14, respectively, are represented by the same, corresponding reference number, except for the suffix “d” in the numerals of the latter. In the second alternative of the second embodiment of the rearview mirror subassembly 10d, the bezel 28d abuts against the front face of the reflective element 14d similar to the first alternative of the first embodiment of the rearview mirror subassembly 10 discussed above. As illustrated in FIG. 14, the extension 130d extending from the rear housing section 24d includes the T-shaped projection 150 with the elastomer 16d encapsulating the T-shaped projection 150. In the second alternative of the second embodiment of the present invention, the elastomer 16d can be located continuously along the edge of the extension 130d or can be interrupted along the edge of the extension 130d. Furthermore, the rear housing section 24d could include a protrusion having the elastomer 16d thereon against the entire rear face of the reflective element 14d or any portion thereof. Accordingly, the reflective element 14d is compressed between the elastomer 16d on the rear housing section 24d and the bezel 28d to maintain the reflective element 14d in position within the housing 12d.

The reference numeral 10d′ (FIG. 14A) generally designates modification of the second alternative of the second embodiment of the rearview mirror subassembly. Since rearview mirror subassembly 10d′ is similar to the previously described rearview mirror subassembly 10d, similar parts appearing in FIG. 14 and FIG. 14A, respectively, are represented by the same, corresponding reference number, except for the suffix “d′” in the numerals of the latter. In the second alternative of the second embodiment of the rearview mirror subassembly 10d′, the bezel 28d′ abuts against the front face of the reflective element 14d′ similar to the second alternative of the first embodiment of the rearview mirror subassembly 10d discussed above. As illustrated in FIG. 14A, the extension 130d′ extending from the rear housing section 24d′ abuts against the elastomer 16d directly deposited onto a rear face of the reflective element 14d′. In the modification of the second alternative of the second embodiment of the present invention, the elastomer 16d′ can be located continuously along the edge of the rear face of the reflective element 14d′ or can be interrupted along the edge of the rear face of the reflective element 14d′. Accordingly, the reflective element 14d′ is compressed between the elastomer 16d′ on the rear face of the reflective element 14d′ and the extension 130d′ of the housing section 24d′ to maintain the reflective element 14d′ in position within the housing 12d′. It is contemplated that the elastomer 16d′ can be directly deposited on the rear face of the reflective element 14d′ by gluing an extruded elastomer 16d′ onto the rear face, molding the elastomer 16d′ onto the rear face, depositing the elastomer 16d′ on the rear face through a screen printing process or in any other manner. Furthermore, it is contemplated that the elastomer 16d′ could be deposited on the front face of the reflective element 14d′ instead of or in addition to the elastomer 16d′ on the rear face of the reflective element 14d′ and in the same manner.

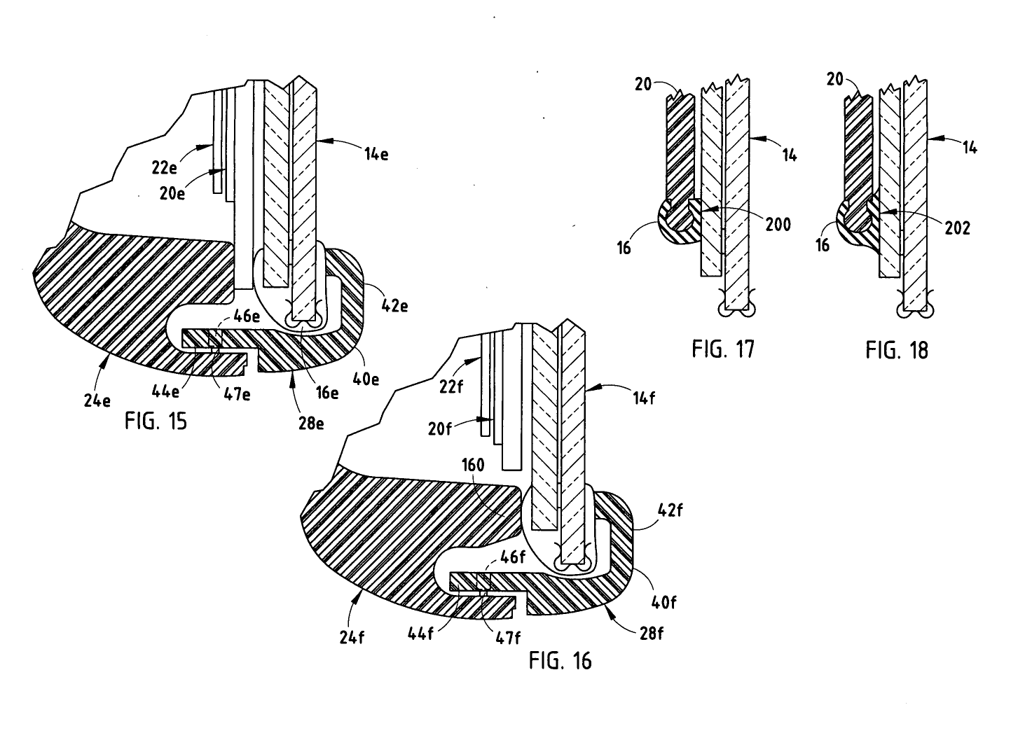

The reference numeral 10e (FIG. 15) generally designates a first alternative of a third embodiment of the rearview mirror subassembly. Since rearview mirror subassembly 10e is similar to the previously described rearview mirror subassembly 10, similar parts appearing in FIGS. 1-8 and FIG. 15, respectively, are represented by the same, corresponding reference number, except for the suffix “e” in the numerals of the latter. In the third embodiment of the rearview mirror subassembly 10c, the elastomer 16e abuts against and encapsulates at least a portion of the perimeter of the reflective element 14e. In the first alternative of the third embodiment of the rearview mirror subassembly 10e, the elastomer 16e is compressed between the looping front flange 42e of the bezel 28e and the carrier board 20e. In the first alternative of the third embodiment of the present invention, the elastomer 16e can be located continuously along the edge of the reflective element 14e or can be interrupted along the edge of the reflective element 14e. Accordingly, the elastomer 16e abuts against and is on the reflective element 14e and is compressed between the bezel 28e and the carrier plate 20e to maintain the reflective element 14e in position within the housing 12e.

The reference numeral 10f (FIG. 16) generally designates a second alternative of the third embodiment of the rearview mirror subassembly. Since rearview mirror subassembly 10f is similar to the previously described rearview mirror subassembly 10e, similar parts appearing in FIG. 15 and FIG. 16, respectively, are represented by the same, corresponding reference number, except for the suffix “f” in the numerals of the latter. In the second alternative of the third embodiment of the rearview mirror subassembly 10f, the elastomer 16f is compressed between the looping front flange 42f of the bezel 28f and an extension 160 of the rear housing section 24f. In the second alternative of the third embodiment of the present invention, the elastomer 16f can be located continuously along the edge of the reflective element 14f or can be interrupted along the edge of the reflective element 14f. Furthermore, the rear housing section 24d could include a protrusion adjacent the entire rear face of the reflective element 14f or any portion thereof, with the reflective element 14f having the elastomer 16f over the rear surface of the reflective element 14f adjacent the protrusion. Moreover, the second alternative of the third embodiment can include the carrier plate 20f and/or the circuit board 22f or the carrier plate 20f and/or the circuit board 22f could be absent from the rearview mirror subassembly 10f. Accordingly, the elastomer 16f abuts against and is on the reflective element 14f and is compressed between the bezel 28f and the carrier plate 20f to maintain the reflective element 14f in position within the housing 12f.

In all of the embodiments described above, the illustrated elastomer 16-16f securely maintains the reflective element 14 in position within the housing 12 of the rearview mirror subsystem 10. The elastomer 16 has a rating on the durometer scale of about 10-60 durometer on the Shore D scale, and most preferably about 25-35 durometer. Furthermore, the durometer of the elastomer 16 is preferably consistent for all temperatures of use of the elastomer 16 (i.e., for the entire temperature range a vehicle experiences during normal use). The elastomer 16 is preferably a thermoplastic elastomer (TPE) such as thermoplastic polyurethane (TPU), thermal plastic polyolefin (TPO, TPV), Styrenic Thermoplastic Elastomer (TPS), Polyester Thermoplastic Elastomer (TPC), Nylon or Polyamide Thermoplastic Elastomer (TPA) or a vulcanized or polymerized rubber, polyurethane, silicone or fluoroelastomer. The elastomer 16 prevents movement of the carrier plate 20 and the reflective element 14 and thereby inhibits associated vibration and noise encountered with a moving carrier plate 20 and/or reflective element 14. Furthermore, pads located between the carrier plate 20 or the rear housing section 24 and the reflective element 14 are not required using the elastomer 16 of the present invention. Therefore, the distortion associated with the reflective element 14 having pads pressing against a rear face thereof is absent in the rearview mirror subassembly 10 of the present invention. Accordingly, the thin front glass element 100 and the rear glass element 102 described above can be used in the rearview mirror subassembly 10 of the present invention without any distortion of the viewing area of the reflective element 14.

In a preferred embodiment of the present invention, the rearview mirror assembly 10-10d is made by co-molding the elastomer 16-16d along with its associated element that the elastomer 16-16d is connected to (e.g., the carrier plate 20, the bezel 28 or the rear housing section 24). Preferably, the element connected to the elastomer 16-16d is molded in a first step and the elastomer 16-16d is molded into position in a second step. Furthermore, in the rearview mirror assembly 10b discussed above, the elastomeric element 116 is also co-molded along with the elastomer 16b and the carrier plate 20b (either before the molding of the elastomer 16b or after the molding of the elastomer 16b).

When using the elastomer 16-16f of the present invention, the elastomer 16-16f will wet out during compression, thereby adhering to the reflective element 14 during compression of the elastomer 16-16f against the reflective element 14. Therefore, the elastomer 16-16f abuts the reflective element 14 with a first compression force after the rearview mirror subassembly 10-10f has been assembled. Under the first compression force, the elastomer 16-16f has an initial contact area 200 (FIG. 17) with the reflective element 14 while the reflective element 14 is abutted against the elastomer 16 with the first compression force. However, as the elastomer 16 is compressed against the reflective element 14, the elastomer 16 has a compression contact area 202 (FIG. 18) with the reflective element 14 while the reflective element is abutting against the elastomer 16 with a second compression force. The second compression force is greater than the first compression force and the compression contact area 202 being greater than the initial contact area 200. Consequently, the elastomer 16 adheres to the reflective element 14 over the compression contact area 202 while the reflective element is abutted against the elastomer 16 during the second compression force. Therefore, if the second compression force is enough force to fracture the reflective element 14, the elastomer 16 will expand its surface area against the rear face of the reflective element 14 to prevent the reflective element 14 from breaking into many small pieces.

In the present invention, a small space between the reflective element 14 and any element located closely behind the reflective element (e.g., carrier plate 20) or when the elastomer 16 abuts against a large portion of the rear face of the reflective element (e.g., extending from the carrier plate 20 or the rear housing section 24), the less the reflective element 14 will be able to bend as the second compression force is applied against the front face of the reflective element 14. Therefore, using the elastomer 16 of the present invention can reduce the risk of fracture of the reflective element 14 during impact of the front face of the reflective element 14 with a head or any other object. Accordingly, aspects of the present invention (e.g., small space to deform and wetting out of the elastomer) provide for preventing fracture of the reflective element 14 during impact of any object with the reflective element 14.

It will be appreciated by those skilled in the art that various other vehicle accessories and components may be incorporated in the previously described rearview mirror subassembly 10 for a vehicle in whole or in part and in various combinations. Such vehicle accessories and components may be mounted within, on or to the housing 12, the mounting bracket 18, attachment to the mirror housing 12 or the mounting bracket 18, or in a console or other housing associated with the interior rearview mirror having the rearview mirror subassembly 10 of the present invention. Additionally, any such vehicle accessories may share components with one another, such as processors, sensors, power supplies, wire harnesses and plugs, displays, switches, antennae, etc. Examples of other vehicle accessories, components or features are described further below.

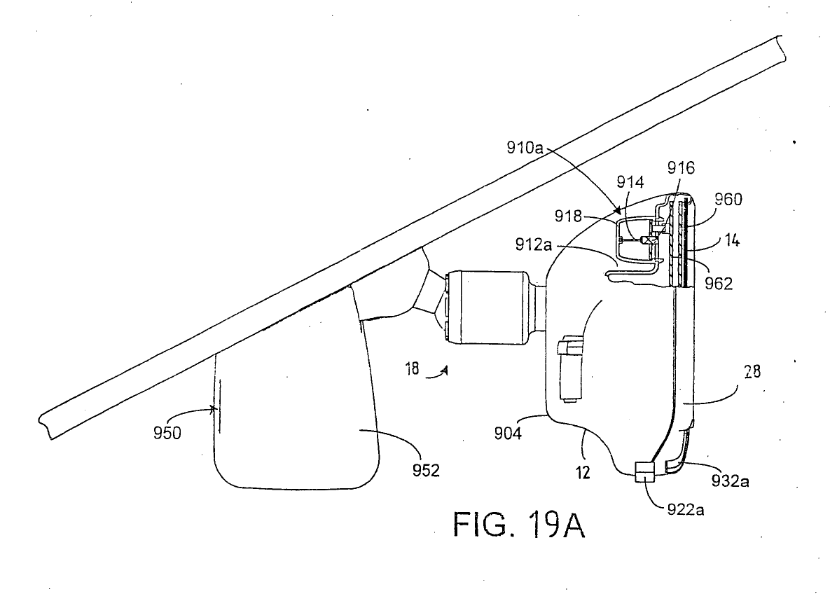

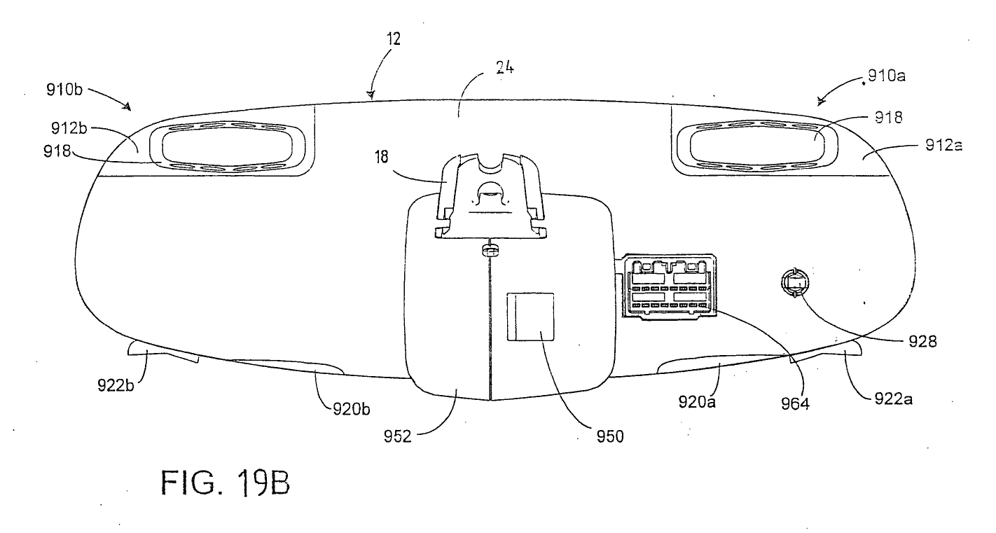

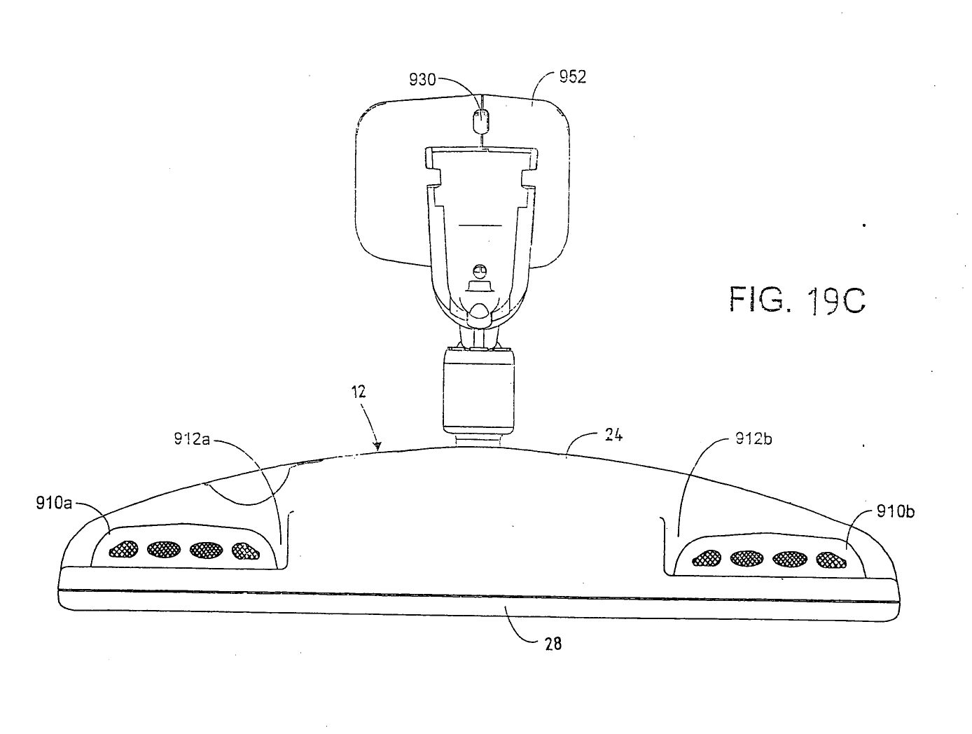

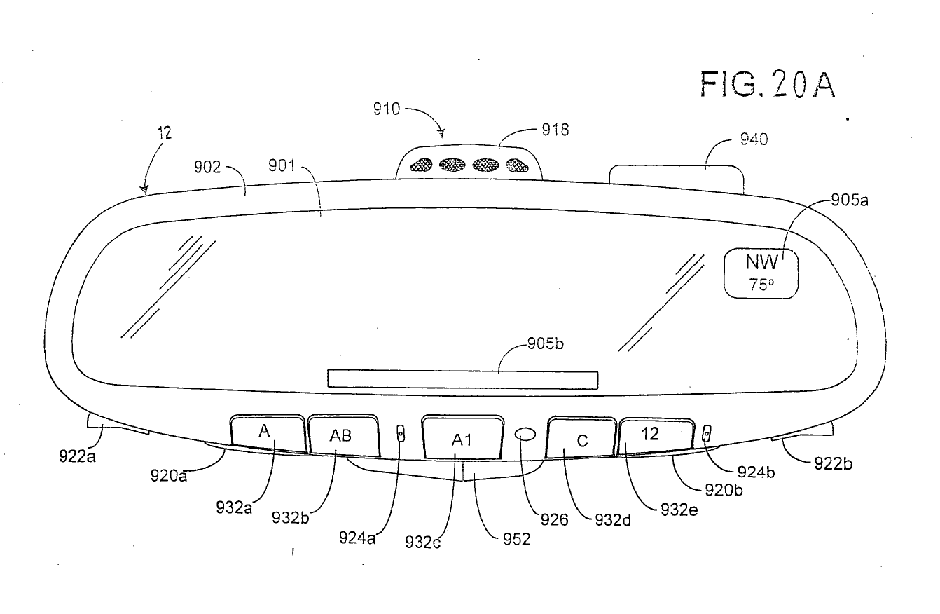

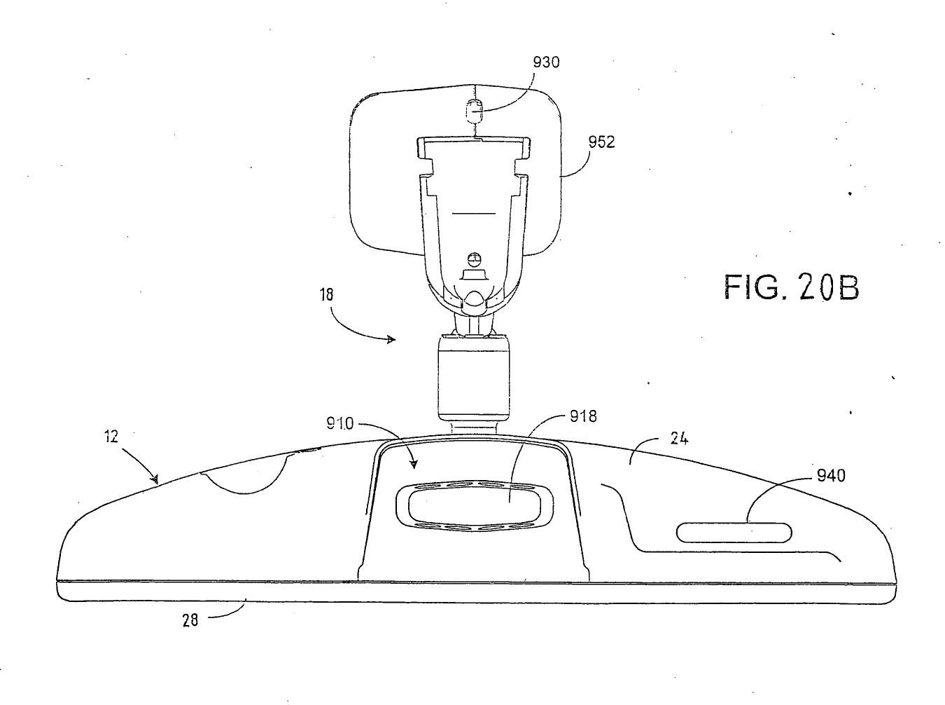

An example of a system incorporated in the interior rearview mirror includes an electronic compass system within the housing 12 of the interior rearview mirror as described in U.S. Patent Application No. 60/449,828 entitled ELECTRONIC COMPASS SYSTEM, the entire contents of which are incorporated in its entirety herein by reference. FIGS. 19A-19C show another embodiment of the interior rearview mirror in which any of the electronic compass systems described in U.S. Patent Application No. 60/449,828 are incorporated. As illustrated in FIGS. 19A-19C, the housing 12 comprises a bezel 28 and a rear housing section 24. The bezel 28 and the rear housing section 24 combine to define the housing 12 for incorporation of features in addition to a reflective element 14 and information displays 905a and 905b. Commonly assigned U.S. Pat. Nos. 6,102,546, D410,607, 6,407,468, 6,420,800, and 6,471,362, the disclosures of which are incorporated in their entireties herein by reference, describe examples of various bezels, cases and associated button constructions that may be used with the present invention.

As depicted in FIGS. 19A-19C, the interior rearview mirror may comprise first and second microphones 910a and 910b. Examples of microphones for use with the present invention are described in commonly assigned U.S. patent application Ser. Nos. 09/444,176 and 09/724,119, U.S. Patent Application Publication No. U.S. 2002/0110256 A1, and PCT Application No. PCT/US02/32386, the disclosures of which are incorporated in their entireties herein by reference. Although the two microphones are shown as being mounted to the backside of rear housing section 24, one or more such microphones may be mounted on the top of the interior rearview mirror (as shown in FIGS. 20A and 20B), on the bottom of the interior rearview mirror, or anywhere within the rear housing section 24 or bezel 28. Preferably, two microphones 910a and 910b are incorporated, one near each end, into the interior rearview mirror on the backside of the rear housing section 24 within recessed portions 912a and 912b. As shown in FIG. 19A, the microphones are constructed with acoustic dam 914 extending around transducer 916 within microphone housing 918. Additional details of this preferred construction are disclosed in commonly assigned International PCT Application No. PCT/US02/32386, the entire disclosure of which is incorporated herein by reference. The audio systems including the microphones may be integrated, at least in part, in a common control with information displays and/or may share components with the information displays. In addition, the status of these systems and/or the devices controlled thereby may be displayed on the associated information displays.

As shown in FIGS. 20A and 20B, a single microphone 910 is provided on the top side of the housing 12. In this construction, it is preferable to include two transducers in microphone housing 918 in a manner similar to that disclosed in the above-referenced International PCT Application No. PCT/US02/32386 and U.S. Patent Application Publication No. U.S. 2002/0110256 A1.

The interior rearview mirror may include first and second illumination assemblies 920a and 920b. Various illumination assemblies and illuminators for use with the present invention are described in commonly assigned U.S. Pat. Nos. 5,803,579, 6,335,548, 6,441,943, 6,521,916, and 6,523,976, as well as commonly assigned U.S. patent application Ser. Nos. 09/723,675, 10/078,906, and 10/230,804, the disclosures of which are incorporated in their entireties herein by reference. Each illumination assembly preferably comprises a reflector, a lens and an illuminator (not shown). There may be two illumination assemblies generally positioned to illuminate a front passenger seat area and the second generally positioned to illuminate a driver seat area. Alternatively, there may be only one illumination assembly that illuminates both seat areas and/or there may be additional illuminator assemblies such as one to illuminate a center console area, overhead console area or area between the front seats.

The interior rearview mirror may also include first and second switches 922a and 922b. Suitable switches for use with the present invention are described in detail in commonly assigned U.S. Pat. Nos. 6,407,468, 6,420,800, 6,426,568, and 6,471,362, as well as commonly assigned U.S. Patent Application Publication No. U.S. 2002/0024713 A1, the disclosures of which are incorporated in their entireties herein by reference. These switches may be incorporated to control the illumination assemblies, the displays, the mirror reflectivity, a voice activated system, a compass system, a telephone system, a highway toll booth interface, a telemetry system, a headlight controller, a rain sensor, a tire pressure monitoring system, a navigation system, a lane departure warning system, adaptive cruise control system, etc. Any other display or system described herein or within the references incorporated by reference may be incorporated in any location within the associated vehicle and may be controlled using the switches.

The interior rearview mirror may also include first and second indicators 924a and 924b. Various indicators for use with the present invention are described in commonly assigned U.S. Pat. Nos. 5,803,579, 6,335,548, 6,441,943, 6,521,916, and 6,523,976, as well as commonly assigned U.S. patent application Ser. Nos. 09/723,675, 10/078,906, and 10/230,804, the disclosures of which are incorporated in their entireties herein by reference. These indicators may indicate the status of the displays, the mirror reflectivity, a voice activated system, a compass system, a telephone system, a highway toll booth interface, a telemetry system, a headlight controller, a rain sensor, a security system, etc. Any other display or system described herein or within the references incorporated by reference may be incorporated in any location within the associated vehicle and may have a status depicted by the indicators.

The interior rearview mirror may further include first and second light sensors 926 and 928 serving as glare and ambient sensors, respectively. Preferred light sensors for use within the present invention are described in detail in commonly assigned U.S. Pat. Nos. 5,923,027, 6,313,457, 6,359,274, 6,379,013, and 6,402,328, U.S. Patent Application Publication No. U.S. 2002/0056806 A1, and in U.S. patent application Ser. No. 10/068,540, the disclosures of which are incorporated in their entireties herein by reference. The glare sensor 926 and/or ambient sensor 928 automatically control the reflectivity of a self dimming reflective element as well as the intensity of information displays and/or backlighting. The glare sensor 926 may also be used to sense headlights of trailing vehicles and the ambient sensor is used to detect the ambient lighting conditions that the system is operating within. In another embodiment, a sky sensor 930 may be incorporated positioned to detect light levels generally above and in front of associated vehicle. The sky sensor 930 may be used to automatically control the reflectivity of a self-dimming element, the exterior lights of a controlled vehicle and/or the intensity of information displays. The interior rearview mirror may further include sun-load sensors for sensing light levels towards the driver side and passenger side of the vehicle so as to control the climate control system of the vehicle.

Additionally, the interior rearview mirror may include first, second, third, fourth and fifth operator interfaces 932a-932e located in the bezel 28. Each operator interface is shown to comprise a backlit information display “A,” “AB,” “A1,” “49,” and “12”. It should be understood that these operator interfaces can be incorporated anywhere in the associated vehicle, for example, in the mirror case, accessory module, instrument panel, overhead console, dash board, seats, center console, etc. Suitable switch construction is described in detail in commonly assigned U.S. Pat. Nos. 6,407,468, 6,420,800, 6,426,568, and 6,471,362, as well as, commonly assigned U.S. Patent Application Publication No. U.S. 2002/0024713 A1, the disclosures of which are incorporated in their entireties herein by reference. These operator interfaces may control the illumination assemblies, the displays, the mirror reflectivity, a voice activated system, a compass system, a telephone system, a highway toll booth interface, a telemetry system, a headlight controller, a rain sensor, a tire pressure monitoring system, a navigation system, a lane departure warning system, adaptive cruise control system, etc. Any other display or system described herein or within the references incorporated by reference may be incorporated in any location within the associated vehicle and may be controlled using an operator interface or interfaces. For example, a user may program a display or displays to depict predetermined information or may program a display or displays to scroll through a series of information, or may enter set points associated with certain operating equipment with associated sensor inputs to display certain information upon the occurrence of a given event. In one embodiment, for example, a given display may be in a non-illuminated state until the engine temperature is above a threshold, the display then automatically is set to display the engine temperature. Another example is that proximity sensors located on the rear of a vehicle may be connected to a controller and combined with a display in a rearview mirror to indicate to a driver the distance to an object; the display may be configured as a bar that has a length proportional to the given distance.

Although specific locations and numbers of these additional features are depicted in FIGS. 19A-19C and 20A and 20B, it should be understood that fewer or more individual devices may be incorporated in any location within the associated vehicle and as described within the references incorporated herein.

A mounting bracket 18 is included for mounting the interior rearview mirror within a vehicle either to the windshield, or to the vehicle roof structure. It should be understood that a host of accessories may be incorporated into the mounting bracket 18 or into a housing 952 attached to the mounting bracket 18 such as a rain sensor (and therefore outside of a periphery of the button), a camera, a headlight control, additional microprocessor, additional information displays, compass sensors, etc. These systems may be integrated, at least in part, in a common control with information displays and/or may share components with the information displays. In addition, the status of these systems and/or the devices controlled thereby may be displayed on the associated information displays. An example of a rain sensor in a mounting bracket 18 is disclosed in commonly assigned U.S. Patent Application No. 60/472,017, the entire disclosure of which is incorporated in its entirety herein by reference.

The interior rearview mirror is shown in FIG. 19A to further comprise a circuit board 22 on which the compass sensor module (not shown) may be mounted, and a daughter board 962 with an input/output bus interface (not shown).

The electrical output signal from either, or both, of the sensors 926 and 928 may be used as inputs to a controller (not shown) to control the reflectivity of the reflective element 14 and/or the intensity of any one or all of the displays 905a and 905b. The details of various control circuits for use herewith are described in commonly assigned U.S. Pat. Nos. 5,883,605, 5,956,012, 6,084,700, 6,222,177, 6,244,716, 6,247,819, 6,249,369, 6,392,783 and 6,402,328, the disclosures of which are incorporated in their entireties herein by reference. These systems may be integrated, at least in part, in a common control with information displays and/or may share components with the information displays. In addition, the status of these systems and/or the devices controlled thereby may be displayed on the associated information displays.

Although the compass sensor module is described as being mounted to circuit board 22, it should be understood that the sensor module may be located within the mounting bracket 18, with an accessory module of the interior rearview mirror or at any location within an associated vehicle such as under a dash board, in an overhead console, a center console, a trunk, an engine compartment, etc. The above described compass systems may be integrated, at least in part, in a common control with information displays and/or may share components with the information displays. In addition, the status of these systems and/or the devices controlled thereby may be displayed on the associated information displays.

The circuit board 22 may comprise a controller (not shown), such as a microprocessor, and the daughter board 962 may comprise an information display 905a. The microprocessor may, for example, receive signal(s) from the compass sensor module and process the signal(s) and transmit signal(s) to the daughter board to the control display 905a to indicate the corresponding vehicle heading. As described herein and within the references incorporated by reference herein, the controller may receive signal(s) from light sensor(s), rain sensor(s), automatic vehicle exterior light controller(s) (not shown), microphone(s), global positioning systems (not shown), telecommunication systems (not shown), operator interface(s) and a host of other devices, and control the information display(s) to provide appropriate visual indications.

The controller (or controllers) used to control the compass system may, at least in part, control the reflectivity of the reflective element 14, exterior lights, the rain sensor, compass, information displays, windshield wipers, heater, defroster, defogger, air conditioning, telephone system, navigation system, security system, tire pressure monitoring system, a garage door opening transmitter, remote keyless entry, telemetry systems, voice recognition systems such as digital signal processor based voice actuation systems, and vehicle speed. The controller 796 (or controllers) may receive signals from switches and/or sensors associated with any of the devices described herein and in the references incorporated by reference herein to automatically manipulate any other device described herein or described in the references included by reference. The controller may be, at least in part, located outside the interior rearview mirror or may comprise a second controller elsewhere in the vehicle or additional controllers throughout the vehicle. The individual processors may be configured to communicate serially, in parallel, via BLUETOOTH™ protocol, wireless communication, over the vehicle bus, over a CAN bus or any other suitable communication. A multi-pin connector interface 964 may be provided for such external connections.

Exterior light control systems as described in commonly assigned U.S. Pat. Nos. 5,990,469, 6,008,486, 6,130,421, 6,130,448, 6,255,639, 6,049,171, 5,837,994, 6,403,942, 6,281,632, 6,291,812, 6,469,739, 6,465,963, 6,429,594, and 6,379,013, U.S. Patent Application Publication No. U.S. 2002/0005472 A1 and U.S. patent application Ser. Nos. 09/528,389, 09/678,586, 09/800,460, 60/404,879, 60/394,583, 10/235,476, and 10/208,142, the disclosures of which are incorporated in their entireties herein by reference, may be incorporated in accordance with the present invention. These systems may be integrated, at least in part, in a common control with information displays and/or may share components with the information displays. In addition, the status of these systems and/or the devices controlled thereby may be displayed on the associated information displays. As disclosed in U.S. patent application Ser. No. 09/800,460, both the compass sensors and the imaging sensor array 950, may be housed in accessory housing 952 attached to the mount bracket 18.

Moisture sensors and windshield fog detector systems are described in commonly-assigned U.S. Pat. Nos. 5,923,027 and 6,313,457 and U.S. patent application Ser. Nos. 09/970,728 and 09/970,962, the disclosures of which are incorporated in their entireties herein by reference. These systems may be integrated, at least in part, in a common control with information displays and/or may share components with the information displays. In addition, the status of these systems and/or the devices controlled thereby may be displayed on the associated information displays.

Commonly assigned U.S. Pat. No. 6,262,831, the disclosure of which is incorporated herein by reference in its entirety, describes power supplies for use with the present invention. These systems may be integrated, at least in part, in a common control with information displays and/or may share components with the information displays. In addition, the status of these systems and/or the devices controlled thereby may be displayed on the associated information displays.

The interior rearview mirror may further include one or more antennae 940 for receipt and/or transmission of RF signals. Appropriate receiving, transmitting, and/or processing circuitry may further be included in or attached to the interior rearview mirror. Such antennae may be used for a cellular telephone system, a BLUETOOTH™ transmitting/receiving system, a remote keyless entry (RKE) system, a trainable garage door opener system, a tire pressure monitoring system, a global positioning satellite system, a LORAN system, etc. Some of these systems may share a common antenna and receiving, transmitting, processing, and display circuits where appropriate. Examples of a tire pressure monitoring system incorporated in an interior rearview mirror system are disclosed in commonly assigned U.S. Pat. Nos. 6,215,389 and 6,431,712 and in U.S. patent application Ser. Nos. 09/359,144 and 09/949,955, the entire disclosures of which are incorporated herein by reference. Examples of a GPS system incorporated in the interior rearview mirror are disclosed in commonly assigned U.S. Pat. Nos. 6,166,698, 6,297,781, 6,396,446, and in U.S. Patent Application Publication No. U.S. 2002/0032510 A1, the entire disclosures of which are incorporated herein by reference. An example of a LORAN system incorporated in an interior rearview mirror system is disclosed in commonly assigned U.S. Patent Application Publication No. U.S. 2002/0193946 A1, the entire disclosure of which is incorporated herein by reference. An example of both a telephone/telematics system and a BLUETOOTH™ system incorporated in an interior rearview mirror system is disclosed in commonly assigned U.S. Patent Application Publication No. U.S. 2002/0032510 A1, the entire disclosure of which is incorporated herein by reference. Examples of a trainable garage door opening systems and RKE systems incorporated in an interior rearview mirror system are disclosed in U.S. Pat. No. 6,091,183, the entire disclosures of which are incorporated herein by reference.

The interior rearview mirror may further include an infrared (IR) transmitter/receiver for transmitting/receiving information to and from the interior rearview mirror and possibly to and from the vehicle. An example of such an interior rearview mirror system is disclosed in commonly-assigned U.S. Pat. No. 6,407,712, the entire disclosure of which is incorporated herein by reference.

The interior rearview mirror may further include one or more of the same or different types of displays. Examples of different types of displays include vacuum fluorescent, LCD, reverse LCD, LED, organic LED, dot matrix, backlit indicia, etc. For displays intended to simultaneously display significant amounts of information, the display disclosed in commonly assigned U.S. Pat. No. 6,186,698 may be used, the entire disclosure of which is incorporated herein by reference. Examples of backlit indicia panel displays are disclosed in commonly-assigned U.S. Pat. Nos. 6,170,956 and 6,356,376 and in U.S. patent application Ser. Nos. 09/586,813 and 09/664,151, the entire disclosures of which are incorporated herein by reference. Various displays used in interior rearview mirror systems are disclosed in commonly assigned U.S. Pat. No. 6,356,376 and in U.S. Patent Application Publication No. U.S. 2002/0154379 A1, the entire disclosures of which are incorporated herein by reference.

The wiring for the vehicle accessories in the interior rearview mirror may be run through the mounting bracket 18 and along the windshield (if the mounting bracket 18 does not already extend to the headliner) under the wire cover 37. An example of an interior rearview mirror system in which the wiring for accessories in the housing 12 are routed through the mounting bracket 18 is disclosed in commonly assigned U.S. Pat. No. 6,467,919, the entire disclosure of which is incorporated herein by reference.

While the present invention has been described as being implemented with the sensors positioned within the housing 12 of the interior rearview mirror, the sensors could be mounted in the mounting foot or in any other location of the interior rearview mirror. Further still, any or all of the various components of the inventive electronic compass may be mounted elsewhere in the vehicle. It will be further appreciated that certain embodiments of the present invention are novel and useful in vehicles such as land-based vehicles (i.e., automobiles, trucks, sport utility vehicles (SUVs), trains, motorcycles, bicycles, mopeds, scooters, snowmobiles, all-terrain vehicles (ATVs), military vehicles) as well as in other vehicles such as airplanes, marine vessels, and amphibious vehicles.

Although the present invention is described as utilizing a process whereby the signals output from the magnetic sensing circuit are plotted in reference to one another in a two- or three-dimensional coordinate system, an analogous approach may be to process and analyze the signals separately and then compare the results of the separate analysis to arrive at a similar result.

The above description is considered that of the preferred embodiments only. Modifications of the invention will occur to those skilled in the art and to those who make or use the invention. For example, the T-shaped top edge 62, and the T-shaped bottom edge 64 of the panel 50 of the carrier plate 20 or the T-shaped protrusion 70 of the looping flange 42a of the bezel 28a could be any shape and many attachment methods could be used to connect the elastomer to the edges 62, 64 or the looping flange 42a. Therefore, it is understood that the embodiments shown in the drawings and described above are merely for illustrative purposes and not intended to limit the scope of the invention.

Moreover, the foregoing detailed description is considered that of a preferred embodiment only, and the particular shape and nature of at least some of the components in this embodiment are at least partially based on manufacturing advantages and considerations as well as on those pertaining to assembly and operation. Modifications of this embodiment may well occur to those skilled in the art and to those who make or use the invention after learning the nature of this preferred embodiment, and the invention lends itself advantageously to such modification and alternative embodiments. Therefore, it is to be understood that the embodiment shown in the drawings and described above is provided principally for illustrative purposes and should not be used to limit the scope of the invention.

As will be seen and appreciated by those skilled in the art, the present invention contemplates the following major points of achievement, as well as others inherent in the disclosure.

1. A rearview mirror subassembly for a vehicle comprising:
a housing;
a reflective element in the housing, the reflective element having a perimeter; and
an elastomer abutting at least a portion of the perimeter of the reflective element to thereby maintain the reflective element in position within the housing.

2. The rearview mirror subassembly of claim 1, wherein:
the housing includes a carrier plate located adjacent a rear of the reflective element.

3. The rearview mirror subassembly of claim 2, wherein:
the housing includes a bezel located adjacent a front of the reflective element.

4. The rearview mirror subassembly of claim 3, wherein:
the elastomer is on the carrier plate.

5. The rearview mirror subassembly of claim 3, wherein:
the elastomer is on the bezel.

6. The rearview mirror subassembly of claim 2, wherein:
the elastomer is on the carrier plate.

7. The rearview mirror subassembly of claim 6, wherein:
the elastomer is co-molded with the carrier plate.

8. The rearview mirror subassembly of claim 6, wherein:
the elastomer is located at a top edge and a bottom edge of the carrier plate.

9. The rearview mirror subassembly of claim 6, further including:
a circuit board connected to the carrier plate.

10. The rearview mirror subassembly of claim 9, wherein:
an elastomeric material is located between the carrier plate and the circuit board.

11. The rearview mirror subassembly of claim 10, wherein:
the elastomer and the elastomeric material are co-molded with the carrier plate.

12. The rearview mirror subassembly of claim 9, wherein:
the carrier plate includes pegs inserted into openings in the circuit board to connect the circuit board to the carrier plate.

13. The rearview mirror subassembly of claim 1, wherein:
the housing includes a bezel located adjacent a front of the reflective element.

14. The rearview mirror subassembly of claim 13, wherein:
the elastomer is on the bezel.

15. The rearview mirror subassembly of claim 13, wherein:
the housing includes a rear housing section located adjacent a rear of the reflective element.

16. The rearview mirror subassembly of claim 15, wherein:
the elastomer is on the bezel.

17. The rearview mirror subassembly of claim 15, wherein:
the elastomer is on the rear housing section.

18. The rearview mirror subassembly of claim 1, wherein:
the reflective element comprises an electrochromic mirror subassembly including a front glass element and a rear glass element, with electrochromic material located between the front glass element and the rear glass element.

19. The rearview mirror subassembly of claim 1, wherein:
the elastomer also abuts at least a portion of a central area of the reflective element to thereby assist in maintaining the reflective element in position within the housing.

20. The rearview mirror subassembly of claim 1, wherein:
the elastomer abuts a top edge and a bottom edge of the reflective element.

21. The rearview mirror subassembly of claim 20, wherein:
the elastomer abutting at least one of the top edge and the bottom edge of the reflective element is continuous.

22. The rearview mirror subassembly of claim 20, wherein:
the elastomer abutting at least one of the top edge and the bottom edge of the reflective element is interrupted.

23. The rearview mirror subassembly of claim 1, wherein:
a force of the elastomer against the reflective element is constant for all temperatures.

24. The rearview mirror subassembly of claim 1, wherein:
the elastomer is directly deposited on the reflective element.

25. A rearview mirror subassembly for a vehicle comprising:
a housing;
a reflective element in the housing; and
an elastomer abutting at least a portion of the reflective element to thereby compress the reflective element between a portion of the housing and the elastomer;
wherein the compression of the reflective element is constant for all temperatures.

26. The rearview mirror subassembly of claim 25, wherein:
the housing includes a carrier plate located adjacent a rear of the reflective element.

27. The rearview mirror subassembly of claim 26, wherein:
the housing includes a bezel located adjacent a front of the reflective element.

28. The rearview mirror subassembly of claim 27, wherein:
the elastomer is on the carrier plate.

29. The rearview mirror subassembly of claim 27, wherein:
the elastomer is on the bezel.

30. The rearview mirror subassembly of claim 26, wherein:
the elastomer is on the carrier plate.

31. The rearview mirror subassembly of claim 30, wherein:
the elastomer is co-molded with the carrier plate.

32. The rearview mirror subassembly of claim 30, wherein:
the elastomer is located at a top edge and a bottom edge of the carrier plate.

33. The rearview mirror subassembly of claim 30, further including:
a circuit board is connected to the carrier plate.

34. The rearview mirror subassembly of claim 33, wherein:
an elastomeric material is located between the carrier plate and the circuit board.

35. The rearview mirror subassembly of claim 34, wherein:
the elastomer and the elastomeric material are co-molded with the carrier plate.

36. The rearview mirror subassembly of claim 33, wherein:
the carrier plate includes pegs inserted into openings in the circuit board to connect the circuit board to the carrier plate.

37. The rearview mirror subassembly of claim 25, wherein:
the housing includes a bezel located adjacent a front of the reflective element.

38. The rearview mirror subassembly of claim 37, wherein:
the elastomer is on the bezel.

39. The rearview mirror subassembly of claim 37, wherein:
the housing includes a rear housing section located adjacent a rear of the reflective element.

40. The rearview mirror subassembly of claim 39, wherein:
the elastomer is on the bezel.

41. The rearview mirror subassembly of claim 39, wherein:
the elastomer is on the rear housing section.

42. The rearview mirror subassembly of claim 25, wherein:
the reflective element comprises an electrochromic mirror subassembly including a front glass element and a rear glass element, with electrochromic material located between the front glass element and the rear glass element.

43. The rearview mirror subassembly of claim 25, wherein:
the elastomer also abuts at least a portion of a central area of the reflective element to thereby assist in maintaining the reflective element in position within the housing.

44. The rearview mirror subassembly of claim 25, wherein:
the elastomer abuts a top edge and a bottom edge of the reflective element.

45. The rearview mirror subassembly of claim 44, wherein:
the elastomer abutting at least one of the top edge and the bottom edge of the reflective element is continuous.

46. The rearview mirror subassembly of claim 44, wherein:
the elastomer abutting at least one of the top edge and the bottom edge of the reflective element is interrupted.

47. The rearview mirror subassembly of claim 25, wherein:
the elastomer abuts at least a portion of a perimeter of the reflective element.

48. The rearview mirror subassembly of claim 25, wherein:
the elastomer is directly deposited on the reflective element.

49. A rear view subassembly for a vehicle comprising:
a housing; and
a reflective element in the housing;
an elastomer in the housing abutting the reflective element with a first compression force, the elastomer having an initial contact area with the reflective element while the reflective element is abutted against the elastomer with the first compression force, the elastomer having a compression contact area with the reflective element while the reflective element is abutting against the elastomer with a second compression force, the second compression force being greater than the first compression force and the compression contact area being greater than the initial contact area;
wherein the elastomer adheres to the reflective element over the compression contact area while the reflective element is abutted against the elastomer during the second compression force.

50. The rearview mirror subassembly of claim 49, wherein:
the housing includes a carrier plate located adjacent a rear of the reflective element.

51. The rearview mirror subassembly of claim 50, wherein:
the housing includes a bezel located adjacent a front of the reflective element.

52. The rearview mirror subassembly of claim 51, wherein:
the elastomer is on the carrier plate.

53. The rearview mirror subassembly of claim 51, wherein:
the elastomer is on the bezel.

54. The rearview mirror subassembly of claim 50, wherein:
the elastomer is on the carrier plate.

55. The rearview mirror subassembly of claim 54, wherein:
the elastomer is co-molded with the carrier plate.

56. The rearview mirror subassembly of claim 54, wherein:
the elastomer is located at a top edge and a bottom edge of the carrier plate.

57. The rearview mirror subassembly of claim 54, further including:
a circuit board connected to the carrier plate.

58. The rearview mirror subassembly of claim 57, wherein:
an elastomeric material is located between the carrier plate and the circuit board.

59. The rearview mirror subassembly of claim 58, wherein:
the elastomer and the elastomeric material are co-molded with the carrier plate.

60. The rearview mirror subassembly of claim 57, wherein:
the carrier plate includes pegs inserted into openings in the circuit board to connect the circuit board to the carrier plate.

61. The rearview mirror subassembly of claim 49, wherein:
the housing includes a bezel located adjacent a front of the reflective element.

62. The rearview mirror subassembly of claim 61, wherein:
the elastomer is on the bezel.

63. The rearview mirror subassembly of claim 61, wherein:
the housing includes a rear housing section located adjacent a rear of the reflective element.

64. The rearview mirror subassembly of claim 63, wherein:
the elastomer is on the bezel.

65. The rearview mirror subassembly of claim 63, wherein:
the elastomer is on the rear housing section.

66. The rearview mirror subassembly of claim 49, wherein:
the reflective element comprises an electrochromic mirror subassembly including a front glass element and a rear glass element, with electrochromic material located between the front glass element and the rear glass element.

67. The rearview mirror subassembly of claim 49, wherein:
the elastomer also abuts at least a portion of a central area of the reflective element to thereby assist in maintaining the reflective element in position within the housing.

68. The rearview mirror subassembly of claim 49, wherein:
the elastomer abuts a top edge and a bottom edge of the reflective element.

69. The rearview mirror subassembly of claim 68, wherein:
the elastomer abutting at least one of the top edge and the bottom edge of the reflective element is continuous.

70. The rearview mirror subassembly of claim 68, wherein:
the elastomer abutting at least one of the top edge and the bottom edge of the reflective element is interrupted.

71. The rearview mirror subassembly of claim 49, wherein:
the elastomer abuts at least a portion of a perimeter of the reflective element.

72. The rearview mirror subassembly of claim 49, wherein:
the elastomer is directly deposited on the reflective element.

73. A method of making a rearview mirror subassembly for a vehicle, the rearview mirror subassembly including a reflective element within a housing, the method comprising:
co-molding a first portion of the housing and an elastomer;
positioning the reflective element within the housing; and
compressing the reflective element between the elastomer and a second portion of the housing to thereby maintain the reflective element in position within the housing.

74. The method of making the rearview mirror subassembly of claim 73, wherein:
the housing includes a carrier plate; and
further including positioning the carrier plate adjacent a rear of the reflective element.

75. The method of making the rearview mirror subassembly of claim 74, wherein:
the housing includes a bezel; and
further including positioning the bezel adjacent a front of the reflective element.

76. The method of making the rearview mirror subassembly of claim 75, wherein:
the first portion is the carrier plate.

77. The method of making the rearview mirror subassembly of claim 75, wherein:
the first portion is the bezel.

78. The method of making the rearview mirror subassembly of claim 74, wherein:
the first portion is the carrier plate.

79. The method of making the rearview mirror subassembly of claim 78, wherein:
co-molding the first portion of the housing and the elastomer comprises molding the elastomer along a top and a bottom edge of the carrier plate.

80. The method of making the rearview mirror subassembly of claim 78, further including:
connecting a circuit board to the carrier plate.

81. The method of making the rearview mirror subassembly of claim 80, further including:
positioning an elastomeric material between the carrier plate and the circuit board.

82. The method of making the rearview mirror subassembly of claim 81, further including:
co-molding the elastomeric material with the carrier plate.

83. The method of making the rearview mirror subassembly of claim 80, wherein:
the carrier plate includes pegs; and
further including inserting the pegs into openings in the circuit board to connect the circuit board to the carrier plate.

84. The method of making the rearview mirror subassembly of claim 73, wherein:
the housing includes a bezel; and
further including positioning the bezel adjacent a front of the reflective element.

85. The method of making the rearview mirror subassembly of claim 84, wherein:
the first portion is the bezel.

86. The method of making the rearview mirror subassembly of claim 84, wherein:
the housing includes a rear housing section; and
further including positioning the rear housing section adjacent a rear of the reflective element.

87. The method of making the rearview mirror subassembly of claim 86, wherein:
the first portion is the bezel.

88. The method of making the rearview mirror subassembly of claim 86, wherein:
the first portion is the rear housing section.

89. The method of making the rearview mirror subassembly of claim 73, wherein:
the reflective element comprises an electrochromic mirror subassembly including a front glass element and a rear glass element, with electrochromic material located between the front glass element and the rear glass element.

90. The method of making the rearview mirror subassembly of claim 73, further including:
abutting at least a portion of a central area of the reflective element with the elastomer to thereby maintain the reflective element in position within the housing.

91. The method of making the rearview mirror subassembly of claim 73, further including:
abutting the elastomer against a top edge and a bottom edge of the reflective element.

92. The method of making the rearview mirror subassembly of claim 91, wherein:
co-molding the first portion of the housing and the elastomer includes molding the elastomer continuously along at least one of the top edge and the bottom edge of the first portion.

93. The method of making the rearview mirror subassembly of claim 91, wherein:
co-molding the first portion of the housing and the elastomer includes interrupting the elastomer along at least one of the top edge and the bottom edge of the first portion.

94. The method of making the rearview mirror subassembly of claim 73, wherein:
compressing the reflective element between the elastomer and a second portion of the housing includes abutting at least a portion of a perimeter of the reflective element with the elastomer.
